(19) United States
(12) Patent Application Publication
(10) Pub. No.: US 2018/0034581 A1
(43) Pub. Date: Feb. 1, 2018

(54) QUALITY OF SERVICE ASSESSMENT FOR CONFERENCES

(71) Applicant: International Business Machines Corporation, Armonk, NY (US)

(72) Inventors: Animesh Gupta, Pune (IN); Shailendra Moyal, Pune (IN); Ishan Rastogi, Pune (IN)

(21) Appl. No.: 15/220,415

(22) Filed: Jul. 27, 2016

(51) Int. Cl. H04L 1/00; H04L 12/26; H04L 29/06

(52) U.S. Cl. CPC H04L 1/0018; H04L 65/1006; H04L 43/0841; H04L 43/0864; H04L 43/087; H04L 43/045

(57) ABSTRACT

A method, executed by a computer, includes sending a test media packet sequence to a client of a plurality of clients, receiving from the client a response packet sequence corresponding to the test media packet sequence, comparing the test media packet sequence to the response packet sequence to determine a quality of service score for the client, and notifying the client of the quality of service score. A computer system and computer program product corresponding to the above method are also disclosed herein.

### BACKGROUND OF THE INVENTION

The present invention relates generally to conferencing, and more specifically, to assessing the quality of service for participants in a conference.

In the field of conferencing, a user may collaborate with remote participants using text, audio, and/or video chat. If a user has poor quality of service, the user may experience poor video or audio quality from participants in a conference. Additionally, the other participants may not be able to see or hear the user clearly. One problem is assessing the quality of service that participants may expect for a conference before initiating the conference itself.

### SUMMARY

As disclosed herein, a method, executed by a computer, includes sending a test media packet sequence to a client of a plurality of clients, receiving from the client a response packet sequence corresponding to the test media packet sequence, comparing the test media packet sequence to the response packet sequence to determine a quality of service score for the client, and notifying the client of the quality of service score. A computer system and computer program product corresponding to the above method are also disclosed herein.

### BRIEF DESCRIPTION OF THE DRAWINGS

FIG. 1 is a block diagram depicting an example of a quality of service assessment system in accordance with embodiments of the present invention;

FIG. 2 is a flow chart depicting an example of a quality of service assessment method in accordance with embodiments of the present invention;

FIG. 3 is a flow chart depicting an example of a conference initiation method in accordance with embodiments of the present invention; and

FIG. 4 is a block diagram depicting one example of a computing apparatus (i.e., computer) suitable for executing the methods disclosed herein.

### DETAILED DESCRIPTION

Embodiments of the present invention relate generally to audio and video conferencing, and more specifically, to assessing the quality of service that conference participants may expect when joining a conference. When a user first join a conference, it may be unclear as to whether the user will be able to clearly communicate with the other participants. For example, while the user may clearly receive audio and/or video from other participants, the user might not realize that the other participants cannot see or hear him. Quality of service may be determined before a conference begins by simulating text, audio, and/or video communication with the exchange of media samples. A test media packet sequence sent to a user may be compared to a response packet sequence received by the user to assess the user's quality of service.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of the invention as set forth hereinafter. The present invention will now be described in detail with reference to the figures.

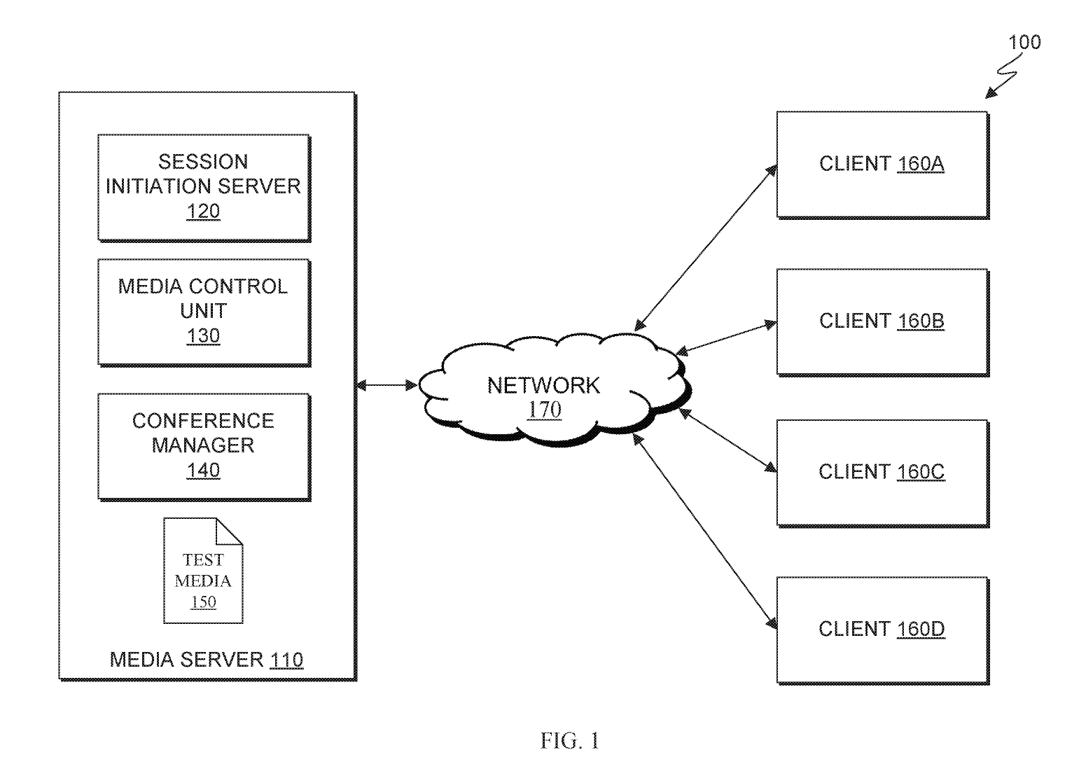

FIG. 1 is a block diagram depicting an example of a quality of service assessment system in accordance with embodiments of the present invention. As depicted, quality of service assessment system 100 includes media server 110 with session initiation server 120, media control unit 130, conference manager 140, and test media 150; clients 160A-160D, and network 170. Media server 110 may host a conference with clients 160A-160D as well as assess the quality of service that clients 160A/160D will experience or are currently experiencing. Media server 110 may host modules such as session initiation server 120, media control unit 130, conference manager 140, provide the modules with computing resources, and provide storage for test media 150.

Session initiation server 120 may initiate sessions or register end points using various protocols, such as session Initiation Protocol (SIP). In some embodiments, session initiation server 120 uses SIP to initiate sessions and/or route text between clients 160A-160D. End points, such as clients 160A-160D, may register with session initiation server 120 in order to make the endpoints available or discoverable for conferencing. In some embodiments, a client registers with session initiation server 120 using SIP by providing session initiation server 120 with the client's IP address, port(s) to be used for conferencing, user account(s) associated with the client, and the like. Thus, conference manager 140 may discover clients and invite them to a conference using session initiation server 120. For example, if client 160A wishes to conference with client 160C, client 160A may send a request to media server 110, which is sent to conference manager 140, which in turn communicates with SIP sever 120 in order to look up client 160C's port and IP address so that conference manager 140 may send an invitation to client 160C.

Media control unit 130 may assess the quality of service for participants of a conference prior to or during the conference. Media control unit 130 may use test media 150 to send a client a test media packet sequence, and may receive from the client a response packet sequence. Test media 150 may include a sample of text, audio, and/or video media that is used by media control unit 130 to assess quality of service. When media control unit 130 has received a response packet sequence, media control unit 130 may compare the response packet sequence to the test media packet sequence to determine the client's quality of service, and may issue the client a quality of service score.

For example, test media 150 may be an audio and video file that media control unit 130 uses as source to send client 160B a test media packet sequence. Client 160B may receive the test media packet sequence and, using the test media packets received, respond with a response packet sequence. If the quality of the connection between client 160B and media server 110 is excellent, the response packet sequence may mostly (or even perfectly) mirror the test media packet sequence, meaning there is no difference in the two, and a file described by the response media packet sequence would be substantially similar or identical to test media 150. If a connection between client 160B and media server 110 is poor, then the response media packet sequence may differ from the test media packet sequence in terms of latency, number of packets, etc. If little or no response media packets are received by media control unit 130, then it may determine that a client will not be able to participate in a conference due to poor or no connectivity.

When assessing quality of service, media control unit 130 may compare a test media packet sequence to its corresponding response packet sequence in terms of response time of packets, jitter, packet loss, round-trip delay time, latency, and the like. Media control unit 130 may also create a media file from the response packet sequence and compare the media file to the original test media 150 in terms of audio quality, video quality, bitrate, resolution, playback length, number of compression artifacts, and the like. Media control unit 130 may assess the quality of service for a client prior to the client joining a conference, and/or at any point during the conference. In some embodiments, media control unit 130 informs a client of its own quality of service and the quality of service of all of the other clients, so that every client is privy to the quality of service of all participants. Media control unit 130 may inform clients of their quality of service in terms of a quality of service score, which may be represented as a rating such as a percentage or an integer score ranging from zero to ten.

Conference manager 140 may initiate a conference for participants, such as clients 160A-160D. In some embodiments, conference manager 140 discovers invitees using registrar information obtained from session initiation server 120, and initiates a conference by inviting all of the participants. Conference manager 140 may provide all of the computing resources necessary to host a conference. In some embodiments, rather than be invited, a client may elect to join a predefined conference shared with the client. When a conference session is active, conference server 140 or media control unit 130 may relay data between all participants using the Real-time Transport Protocol (RTP).

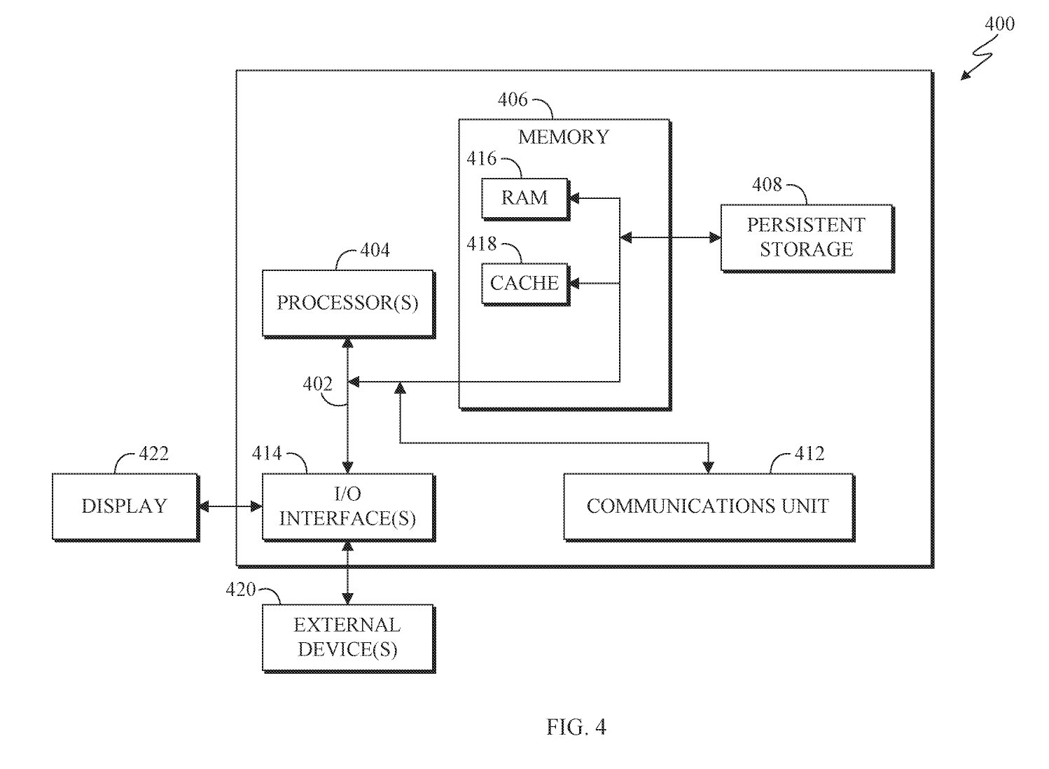

In various embodiments of the present invention, clients 160A-160D may be a laptop computer, a tablet computer, a netbook computer, a personal computer (PC), a desktop computer, a personal digital assistant (PDA), a smart phone, a thin client, or any programmable electronic device capable of executing computer readable program instructions. Clients 160A-160D may include internal and external hardware components, as depicted and described in further detail with respect to FIG. 4. Clients may initially register with media server 110's session initiation server 120 over SIP, and once a conference begins, may communicate with other clients over RTP.

Network 170 may include any sort of network over which media server 110, session initiation server 120, media control unit 130, conference manager 140, and clients 160A-160D may all communicate. Network 170 may be a local network, intranet, wireless network, or the like. In some embodiments, network 170 is the Internet.

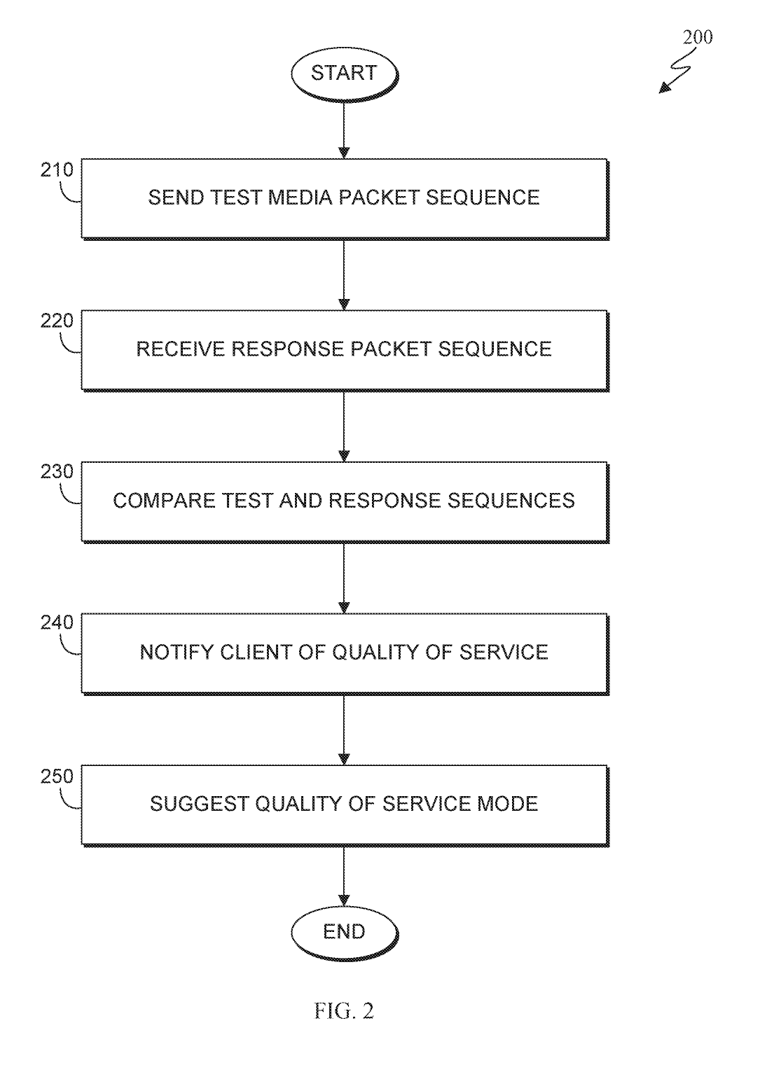

FIG. 2 is a flow chart depicting an example of a quality of service assessment method 200 in accordance with embodiments of the present invention. As depicted, quality of service assessment method 200 includes sending (210) a test sequence, receiving (220) a response sequence, comparing (230) the test and response sequences, notifying (240) the client, and suggesting (250) a QoS mode. Quality of service assessment method 200 may assess the quality of a conference before it begins so that participants may be informed of the degree of coherency and intelligibility that they might expect.

Sending (210) a test media packet sequence may include sending test media 150 as a sequence of packets to one or more clients. The clients may receive the packets from media server 110 and respond with response packets that together form a response packet sequence. A client may respond with a response packet as soon as it receives a test media packet, or the client may respond with a complete (or as nearly complete as possible, in the case of packet loss) response packet sequence upon delivery of the test media packet sequence.

Receiving (220) the response packet sequence may include receiving the response packet sequence transmitted from one or more clients. Media server 110 may relay response packet sequences to media control unit 130, or media control unit 130 may receive directly from the one or more clients 160A-160D.

Comparing (230) the test and response sequences may include comparing the test media packet sequence to the response packet sequence in terms of various metrics. The various metrics may include response time metric, jitter metric, packet loss metric, round-trip delay time metric, and latency metric, where each metric may be derived from executing algorithms that compare the statistics of the test and response packet sequences. Furthermore, as the response packet sequence may be intended to describe a media file, the resulting media file may be compared to the test media 150 so that audio and video quality may be compared. In some embodiments, media control unit 130 may calculate an overall or composite score that takes into account the various metrics and audio and video quality in order to succinctly qualify the quality of service of a client.

Notifying (240) one or more clients of the quality of service may include notifying each client of their own quality of service as well as every other participant's quality of service. Quality of service may be represented using one or more of the quality of service metrics or an overall quality of service composite score. In some embodiments, the quality of service is represented to a user on a client's user interface.

Suggesting (250) a quality of service mode may include suggesting one or more modes to a user of a client depending on the client's quality of service score. Different quality of service modes may include an audio-video mode, an audio-only mode, a text-only mode, or variations on these having various resolutions or bitrates ranging from high to low.

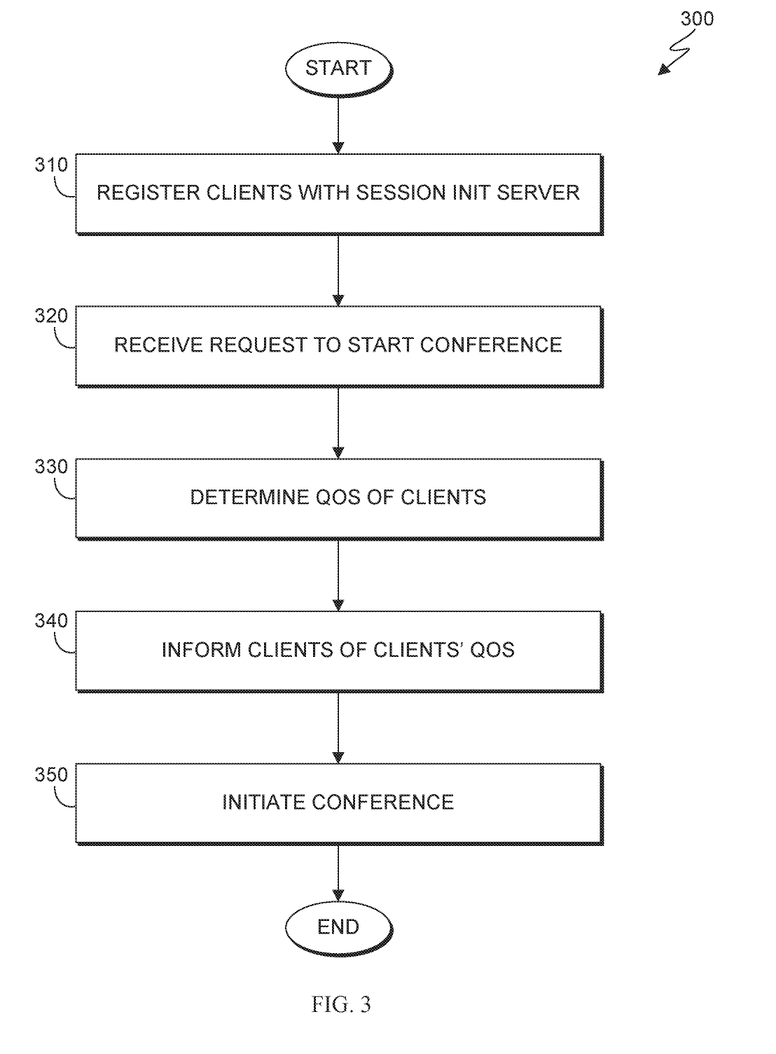

FIG. 3 is a flow chart depicting an example of a conference initiation method 300 in accordance with embodiments of the present invention. As depicted, conference initiation method 300 includes registering (310) clients, receiving (320) a request, determining (330) QoS of clients, informing (340) clients, and initiating (350) the conference. Conference initiation method 300 enables a user to start a conference, invite other participants, assess the participants' quality of service, and share the participants' quality of service with each other.

Registering (310) clients with a session initiation server may include registering the user account(s), IP address, and/or ports of clients 160A-160D with session initiation server 120. Clients may register over SIP. Receiving (320) a request to start a conference may include receiving, over SIP, a request from a particular client to start a conference with other enumerated participants. In some embodiments, the list of participants may not be per se enumerated but may be “all contacts,” “co-workers,” “most recent contact(s)” or the like. Conference manager 140 may then contact and invite participants, using session initiation server 120 to look up the participants' client IP address or other contact information in order to send an invitation.

Determining (330) the quality of service of clients may include determining, for each client that is to be a participant of a conference, their quality of service. In some embodiments, the quality of service is determined by quality of service assessment method 200.

Informing (340) a client of the clients' quality of service may include informing each client 160A-160D of each of the other clients' 160A-160D quality of service, as well as their own, prior to initiation of a conference. The clients may be informed by media server 110 and/or media control unit 130. For example, client 160A may be informed that client 160B can audio- and video-conference with client 160A, that client 160C can only audio-conference with client 160A, and that client 160D is unreachable. Following this example, client 160D may be told that the other clients 160A-160C will not be able to communicate meaningfully with a user of client 160D.

Initiating (350) the conference may include provisioning a virtual conference room, and enabling clients to join the conference. In some embodiments, a conference room is provisioned by conference manager 140, which provides it with an appropriate amount of computing resources. Conference manager 140 may obtain from session initiation server 120 endpoint connection information for SIP signaling in order to invite or add clients 160A-160D to the conference at any time. Clients may join at any time to a predetermined conference room.

FIG. 4 is a block diagram depicting components of a computer 400 suitable for executing the methods disclosed herein. It should be appreciated that FIG. 4 provides only an illustration of one embodiment and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In the depicted embodiment, memory 406 includes random access memory (RAM) 416 and cache memory 418. In general, memory 406 can include any suitable volatile or non-volatile computer readable storage media.

One or more programs may be stored in persistent storage 408 for execution by one or more of the respective computer processors 404 via one or more memories of memory 406. The persistent storage 408 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 408 via I/O interface(s) 414. I/O interface(s) 414 may also connect to a display 422. Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, executed by a computer, the method comprising:
sending, from a conference manager, a test media packet sequence to a client of a plurality of clients;
receiving from the client a response packet sequence corresponding to the test media packet sequence;
comparing the test media packet sequence to the response packet sequence to determine a quality of service score for the client, wherein comparing the test media packet sequence to the response packet sequence comprises comparing a test file comprised of the test media packet sequence to a response file comprised of the response packet sequence, wherein the test file and the response file are stored on the conference manager and compared using the conference manager; and
notifying the client of the quality of service score.

2. The method of claim 1, wherein the quality of service score is based on one or more quality of service metrics selected from the group consisting of a response time metric, a jitter metric, a packet loss metric, a round-trip delay time metric, and a latency metric.

3. (canceled)

4. The method of claim 1, wherein the test media packet sequence comprises a media file having an audio portion and video portion.

5. The method of claim 1, further comprising suggesting to a user of the client to join a conference in a quality of service mode.

6. The method of claim 5, wherein the quality of service mode is selected from the group consisting of a high quality video mode, a low quality video mode, and an audio-only mode, based on the quality of service score of the client.

7. The method of claim 1, wherein notifying the client of the quality of service score comprises displaying to a user of the client the quality of service score.

8. A computer system comprising:
one or more computer processors;
one or more computer readable storage media;
program instructions stored therein for execution by at least one of the one or more computer processors, the program instructions comprising instructions to:
send, from a conference manager, a test media packet sequence to a client of a plurality of clients;
receive from the client a response packet sequence corresponding to the test media packet sequence;
compare the test media packet sequence to the response packet sequence to determine a quality of service score for the client, wherein comparing the test media packet sequence to the response packet sequence comprises comparing a test file comprised of the test media packet sequence to a response file comprised of the response packet sequence, wherein the test file and the response file are stored on the conference manager and compared using the conference manager; and
notify the client of the quality of service score.

9. The computer system of claim 8, wherein the quality of service score is based on one or more quality of service metrics selected from the group consisting of a response time metric, a jitter metric, a packet loss metric, a round-trip delay time metric, and a latency metric.

10. (canceled)

11. The computer system of claim 8, wherein the test media packet sequence comprises a media file having an audio portion and video portion.

12. The computer system of claim 8, further comprising instructions to suggest to a user of the client to join a conference in a quality of service mode.

13. The computer system of claim 12, wherein the quality of service mode is selected from the group consisting of a high quality video mode, a low quality video mode, and an audio-only mode, based on the quality of service score of the client.

14. The computer system of claim 8, wherein instructions to notify the client of the quality of service score comprise instructions to display to a user of the client the quality of service score.

15. A computer program product comprising:
a computer readable storage medium and program instructions stored on the computer readable storage medium, the program instructions comprising instructions to:
send, from a conference manager, a test media packet sequence to a client of a plurality of clients;
receive from the client a response packet sequence corresponding to the test media packet sequence;
compare the test media packet sequence to the response packet sequence to determine a quality of service score for the client, wherein comparing the test media packet sequence to the response packet sequence comprises comparing a test file comprised of the test media packet sequence to a response file comprised of the response packet sequence, wherein the test file and the response file are stored on the conference manager and compared using the conference manager; and
notify the client of the quality of service score.

16. The computer program product of claim 15, wherein the quality of service score is based on one or more quality of service metrics selected from the group consisting of a response time metric, a jitter metric, a packet loss metric, a round-trip delay time metric, and a latency metric.

17. (canceled)

18. The computer program product of claim 15, wherein the test media packet sequence comprises a media file having an audio portion and video portion.

19. The computer program product of claim 15, further comprising instructions to suggest to a user of the client to join a conference in a quality of service mode.

20. The computer program product of claim 19, wherein the quality of service mode is selected from the group consisting of a high quality video mode, a low quality video mode, and an audio-only mode, based on the quality of service score of the client.
